(19) United States
(12) Patent Application Publication
(10) Pub. No.: US 2012/0267369 A1
(43) Pub. Date: Oct. 25, 2012

(54) STORAGE CONTAINER

(75) Inventor: Nikolai DUVIGNEAU, Zichron Yaacov (IL)

(73) Assignee: CURVER LUXEMBOURG SARL, Neidercorn (LU)

(21) Appl. No.: 13/439,234

(22) Filed: Apr. 4, 2012

Related U.S. Application Data
(60) Provisional application No. 61/471,491, filed on Apr. 4, 2011.

(51) Int. Cl. B65D 51/16; B23P 17/04; B65D 6/38; B29C 45/16; B65D 53/06; B65D 45/16

(52) U.S. Cl. 220/203.01; 220/795; 220/324; 220/608; 264/255; 29/527.1

(57) ABSTRACT

Provided is a storage container including a container body having a wall portion and a bottom portion, the container body is configured for airtight storage of material. The storage container further includes a lid member for air-tightly covering the container body, the lid member having a channel defined about the perimeter thereof. A molded silicone seal is mounted in the channel, and is configured to sealingly engage the upper perimeter of the wall portion when the lid is placed on the container body.

### FIELD OF THE SUBJECT MATTER

This presently disclosed subject matter relates to containers and more particularly to airtight storage containers.

### BACKGROUND

There are known containers for storage of products such as food and medications, which are typically configured to maintain freshness of the product stored therein. These containers are provided with a container body and a lid member configured to cover the container body. Some containers include a sealing arrangement providing an air-tight storage of the product stored therein.

### SUMMARY OF THE SUBJECT MATTER

According to one aspect of the presently disclosed subject matter, there is provided a storage container comprising a container body having a wall portion and a bottom portion, the container body configured for airtight storage of material; a lid member for air-tightly covering the container body, the lid member having a channel defined about the perimeter thereof; and a molded silicone seal mounted in the channel, being configured to sealingly engage the upper perimeter of the wall portion when the lid is placed on the container body.

The lid member can be a molded thermoplastic lid member.

The lid can further comprise pressure relief valve mounted thereon.
The storage container can further comprise a latching arrangement configured to secure the lid member to the wall portion. The latching arrangement can be configured to ensure sealing engagement between the silicone seal and the wall portion. The latching arrangement includes at least two latching flaps mounted on the lid member, being configured for snap fit engagement with a shoulder portion on the wall portion.

The silicone seal can include antibacterial component.

The wall portion can include a graduate scale having indicia.

The container body can further include a drainage channel defined about the perimeter of the bottom portion being configured for collecting liquid from the material stored inside the container body. The container body can include a plurality of grooves defined on the bottom portion thereof, which are in flow communication with the channel.

The lid member can further include a valve mounted therein and being configured for releasing pressure accumulated inside the container body, when the lid member is placed thereon. The valve can includes an aperture defined in the lid member for seating a valve stem, and at least one flow port, configured to allow flow of fluids from the container, the flow ports being sealed by a skirt disposed on the outside of the lid member and being coupled to the stem, and configured for radially outwardly deformation thereof in response to pressure accumulating inside the container.

According to another aspect of the presently disclosed there is provided a method for manufacturing a storage container configured for airtight storage of material, and having a container body and a lid member configured for covering the container body and having a channel defined about the perimeter thereof for receiving a wall portion of the container body, the method comprising: injecting a thermoplastic material into a first mold cavity having a shape corresponding to the container body, for forming the container body; injecting a thermoplastic material into a second mold cavity having a shape corresponding to the lid member for forming the lid member and the channel defined therein; and injecting a silicone material into the channel, thereby forming a silicone seal configured for sealing engagement with the wall portion of the container body when the lid member is placed thereon.

The silicone material can further include an antibacterial component configured for eliminating bacteria from inside the container body. The antibacterial component can be nano-silver particles.

The method can further include forming an aperture in the lid member, and mounting therein a valve configured for releasing pressure accumulated inside the container body, when the lid member is placed thereon. The aperture and the flow port can be formed in the injecting process of the led member.

The method can further include providing latching arrangement configured for securing the lid member to a wall portion of the container body.

The latching arrangement can include at least two latching flaps integrally formed on the lid member, being configured for snap fit engagement with a shoulder portion formed along the outside of the wall portion.

The latching flaps can be integrally formed with a hinge line in the form of a flexible portion, configured for pivoting latching flap thereabout. The hinge line can be a living hinge continuously or interruptedly formed along the flaps.

### BRIEF DESCRIPTION OF THE DRAWINGS

In order to understand the presently disclosed subject matter and to see how it can be carried out in practice, examples will now be described, by way of non-limiting examples only, with reference to the accompanying drawings, in which:

FIG. 1a is a perspective top view of a storage container according to an example of the presently disclosed subject matter in a sealed position;

FIG. 1b is a side view of the storage container of FIG. 1a;

FIG. 2a is a perspective top view of the storage container of FIG. 1a without a lid member;

FIG. 2b is a sectional side view of the storage container of FIG. 1a;

FIG. 3 is a perspective bottom view of the storage container of FIG. 1a;

FIG. 4 is a side view of a plurality of stackable storage containers according to an example of the presently disclosed subject matter in a sealed position;

FIG. 5 is a top view of a plurality of stackable storage containers according to an example of the presently disclosed subject matter in a sealed position;

FIG. 6 is a perspective bottom view of a lid member according to an example of the presently disclosed subject matter;

FIG. 7a is a perspective top view of a storage container according to an example of the presently disclosed subject matter in a sealed position;

FIG. 7b is a sectional side view of the storage container of FIG. 7a;

FIG. 8a is a perspective top view of a storage container according to an example of the presently disclosed subject matter without a lid member thereon;

FIG. 8b is a top view of the storage container of FIG. 8a; and,

FIG. 8c is a side sectional view of the storage container of FIG. 8a.

### DETAILED DESCRIPTION OF EMBODIMENTS

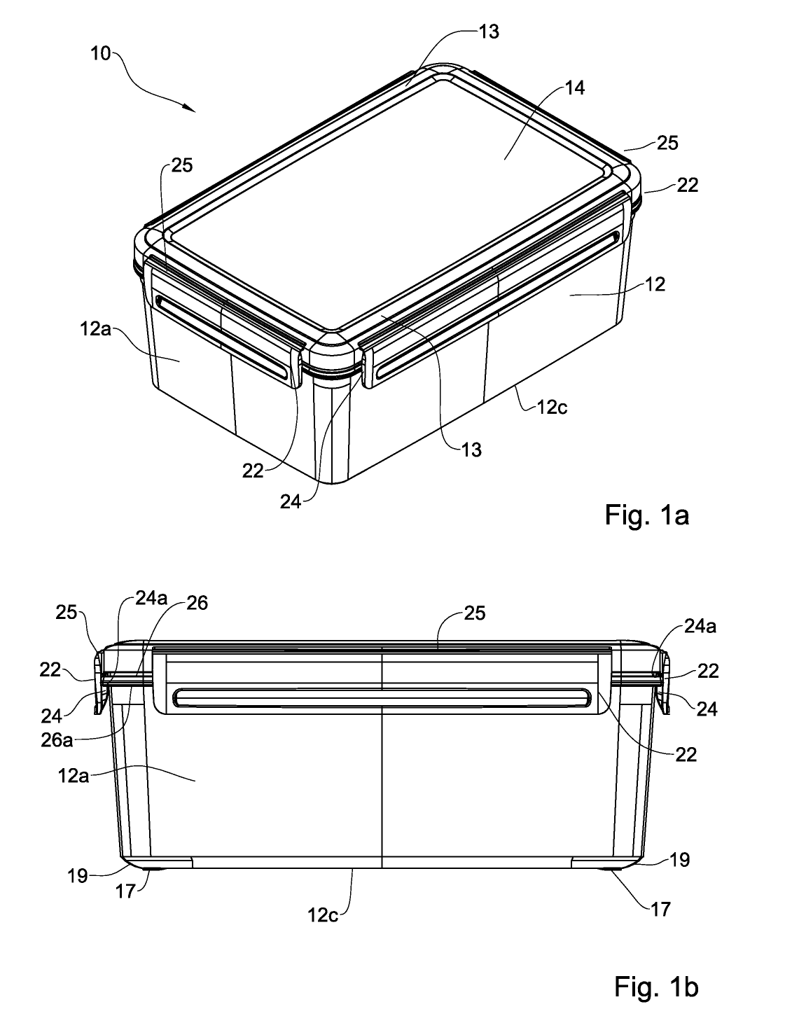

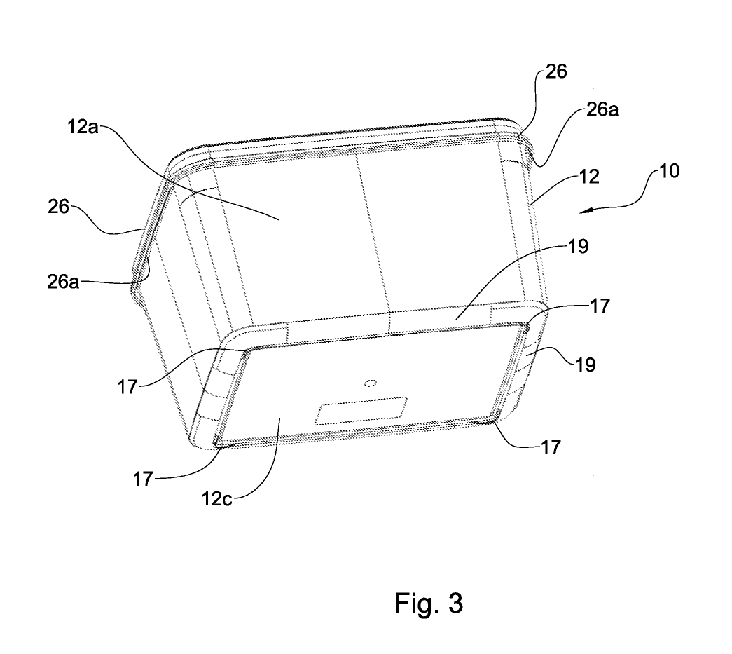

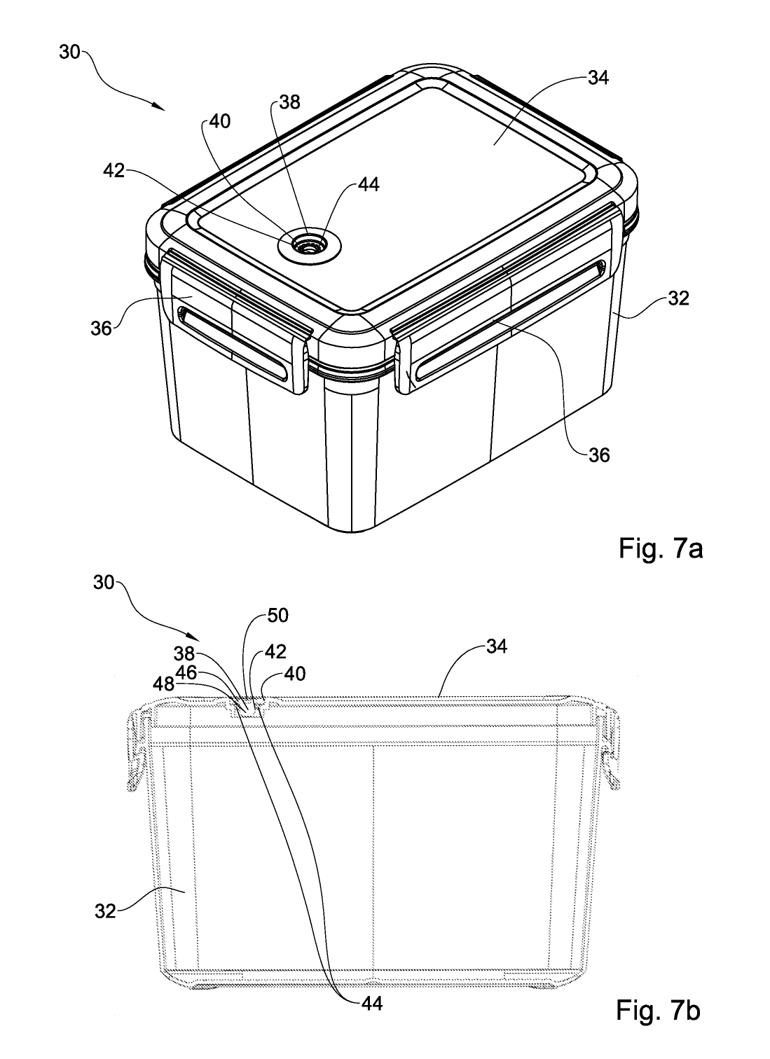

As illustrated in FIGS. 1a to 3, there is provided a storage container 10, having a container body 12, here illustrated as a rectangular body, and a lid member 14 having a corresponding shape configured for covering container body 12. Container body 12 includes a wall portion 12a, and a bottom portion, defining an inside surface 12b, as best seen in FIGS. 7a and 7b, and an outside surface 12c, as seen in FIG. 3. Wall portion 12a, bottom portion, and lid member 14 are configured for airtight storage of material inside container 10.

Lid member 14 includes at least two latching flap 22 pivotally mounted on the edge of lid member 14, and configured for locking engagement with container body 12. Preferably, lid member 14 includes a few latching flaps, so as to secure lid member 14 to container body 12 from all sides. In the illustrated example, the rectangular lid member 14 includes four latching flaps 22, one on each side thereof, for securing to the four walls of the rectangular container body 12.

Latching flaps 22 includes a hinge line 25, which can be a flexible portion (also known as living hinge or integral hinge) integrally formed in latching flap 22, allowing for pivoting latching flap 22. The hinge 25 can be continues along the flaps 22 or alternatively can be interrupted. According to the illustrated example, latching flaps 22 further include a longitudinal projection 24 having an upwardly protrusion 24a, for locking engagement with wall portion 12a.

Wall portion 12a, on the other hand, includes an outwardly extending shoulder 26 defining a recess 26a disposed between wall portion 12a and shoulder 26. Protrusion 24a is configured for snap fit engagement with shoulder 26.

Projection 24 can further include an ergonomically designed portion, here illustrated as a sloped portion 26b defined substantially at the edge of latching flaps 22. The other side projection 24 defining protrusion 24a is disposed substantially at the center of latching flaps 22, aligning with recess 26a. Sloped portion 26b provides space between latching flaps 22 and wall portion 12a, thus allowing the user to insert the tips of his or her fingers in between, and to easily pull latching flaps 22 away from wall portion 12a, so as to release protrusion 24a from recess 26a.

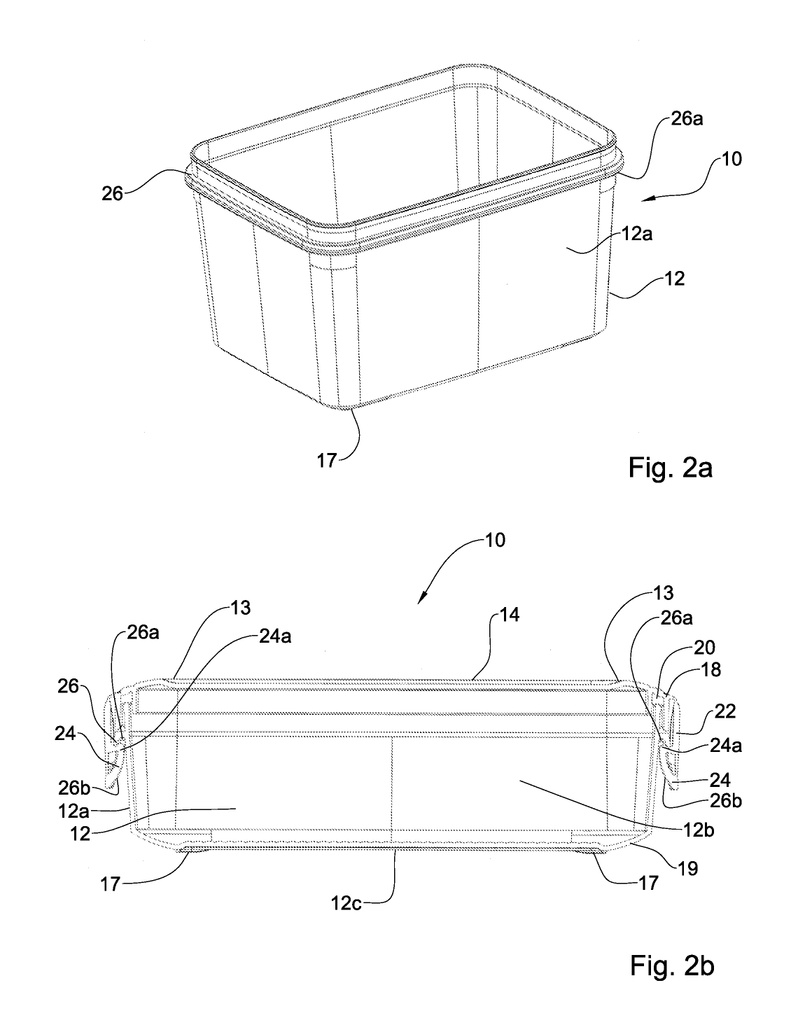

When lid member 14 is placed on container body 12, latching flap 22 can be pivoted toward or away from wall portion 12a to the secured or the unsecured position, respectively. Latching flap 22 can be pivoted toward wall portion 12a, until protrusion 24a abuts the lip of shoulder 26. Further pushing latching flap 22 towards wall portion 12a, urges protrusion 24a inside recess 26a. In this position, as best seen in FIG. 2b, protrusion 24a is locked inside recess 26a by the lip of shoulder 26, thereby securing latching flaps 22 and lid member 14 to container body 12.

Pulling latching flaps 22 away from wall portion 12a, urges protrusion 24a out of recess 26a, thereby, releasing latching flaps 22 and lid member 14 from container body 12.

It will be appreciated that projection 24 and protrusion 24a can extend along the entire length of latching flap 22. Alternatively, each latching flaps 22 can include one or more projections configured for snap-fit engagement with shoulder 26. Similarly, shoulder 26 and recess 26a can be defined around the entire perimeter of wall portion 12a. Alternatively, wall portion 12a can include one or more shoulder segments, each defining a recess 26a, for example, if container body 12 is a rectangular body, as in the illustrated example, each side of wall portion 12a can include one or more shoulder segments. It will be appreciated, that in the latter case, the projections defined on latching flaps 22 is aligned with the shoulder segment defined on wall portion 12a, so as to allow locking engagement thereto.

It will be further appreciated that latching flap 22 and wall portion 12a can include other locking arrangements, as known in the art. It will be further appreciated that container body 12 can be made in such a way which allows the user to selectively cover it with lid member 14 having latching flaps 22, or alternatively, with lid member which does not include such latching flaps.

Still referring to FIG. 1a-3, container 10 can further include a stackable arrangement. For example, lid member 14 can include a raised rim portion 13, here illustrated as a hump, defined about the outside periphery thereof. Outside surface 12c of the bottom portion includes at least one, and preferably a few, leg members 17 defined in close proximity the periphery thereof, for stacking on a lid member of a second container. In order to allow retaining container 10 in place when disposed on a lid member of a second container, leg members 17 are disposed in such away so as to be substantially aligned with the inside of rim portion 13, on the lid member 14. This way, when a first container is placed on a lid member of a second container, leg members 17, on the outside bottom portion 12c of the first container, are disposed substantially adjacent raised rim portion 13 on the lid member 14 of second portion.

It will be appreciated that outside bottom portion 12c can extend outwardly beyond leg members 17, here illustrates as peripheral extension 19, so as to maximize the space inside container 10. However, in the latter case, peripheral extension 19 is slightly raised, substantially at the same height as the height of rim portion 13. This way, when the first container is placed on the lid member of the second container, leg members 17 are bounded by rim portion 13, and peripheral extension 19 is seated over rim portion 13, thereby allowing container 10 to be evenly and horizontally seated on the lid member of the second container.

In the illustrated example, outside bottom portion 12c includes four corner leg members 17, one at each corner thereof. However, according to another example, the leg member can be a peripheral strip configured for bounding the inside of rim portion 13 and container 10 can be placed on another lid member. According to yet another example, rim portion 13, can be defined on one or more segments of the periphery of lid member 14. In this case, the leg members are defined at least on the segments of outside bottom portion 12c, which is aligned with the rim portions, when placed on the lid member.

Accordingly, a plurality of containers can be stacked on one another, and the rim portion and the leg member thereof retain the containers on top of each other. The height of the rim portion and the leg members can be defined in accordance with the level of the required retention. That is to say, the heights of the rim portion and the leg members determine the maximum angle in which the stacked container can be disposed without slipping off one another.

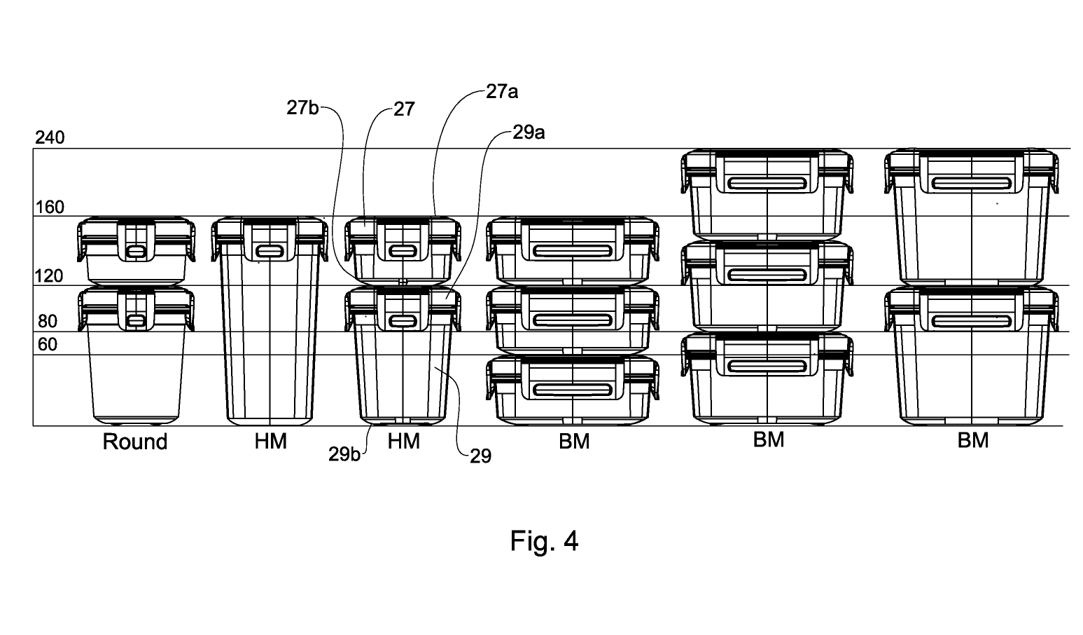

In reference to FIG. 4, a plurality of containers, substantially similar to container 10 of FIGS. 1-3, can be stacked one on top of the other. There is provided in accordance with an example of the presently disclosed subject matter different series of containers, each series includes containers having similar dimension, which are configured to be stacked one on top of another. As seen in FIG. 4 container 27 has a different height than container 29, however since the width and length of lid members 27a and 29a is substantially the same, as well as the width and length of outside bottom portions 27b and 29b, container 27 can be stacked on top of container 29 and vice versa.

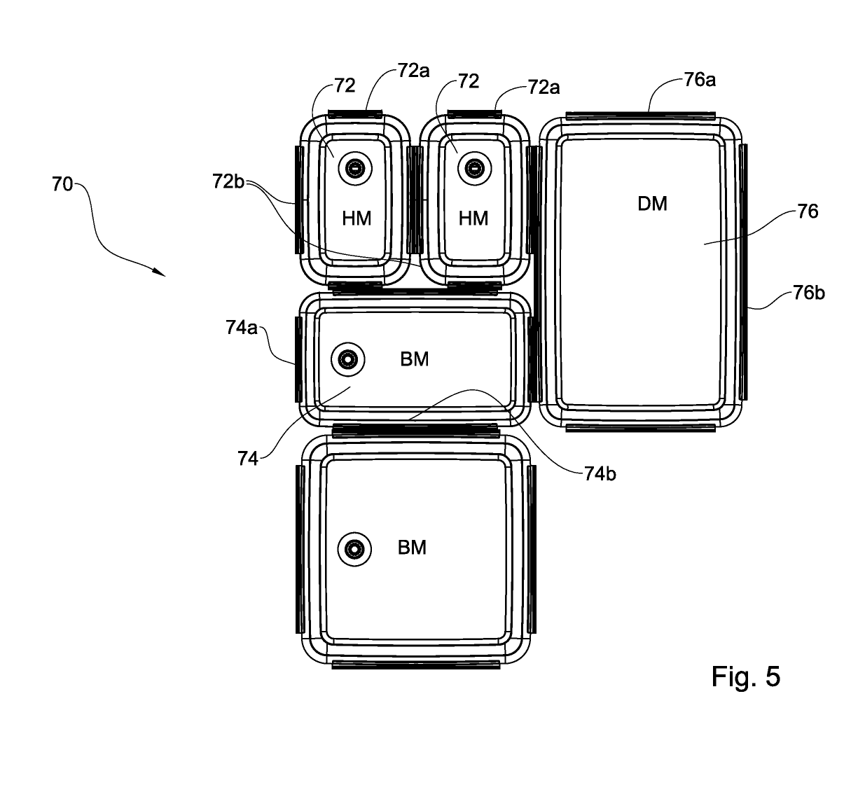

According to a further example, a series of stackable containers substantially the same as container 10 of FIGS. 1-3, each having different dimensions can be provided. As seen in FIG. 5 a series of containers, generally indicated 70, can include two small rectangular containers 72 having substantially the same width 72a and length 72b. In addition, a medium container 74 having larger width 74a and length 74b is provided. Width 74a of medium container 74 is substantially the same as the length 72b of small rectangular containers 72, and length 74b of medium container 74 is configured to hold the length 72b of the two small rectangular containers 72. Thus, small rectangular containers 72 can be disposed on medium container 74. The rim portion defined on the lid member of medium container 74 is configured to engage at least some of leg members defined on the bottom portion of small rectangular containers 72. Thus, two small rectangular containers 72 can be retained in place when stacked on medium container 74.

Similarly, the series can include a large rectangular container 76, having a large width 76a and length 76b. Width 76a of large container 76 is configured to hold width 72a of both small rectangular containers 72. Length 76b of large container 76 is configured to hold length 72b of small rectangular containers 72 together with the width 74a of medium container 74. Thus, large rectangular container 76 is configured to hold two small rectangular containers 72, as well as medium container 74. The rim portion defined on the lid member of large container 76 is configured to engage at least some of leg members defined on the bottom portion of small rectangular containers 72 and medium container 74. Thus, two small rectangular containers 72 and medium container 74, can be retained in place when stacked on medium container 74.

In addition, the containers in series 70 are nestable, that is to say, that each container can be nested inside similar container for efficient storage when the containers is not in use. The side walls of each container are slightly inclined sidewardly, in such a way that the circumference of the wall portion is slightly and gradually reduced from the top thereof toward the bottom thereof. This way, the bottom of each container can be inserted into a substantially similar container. It will be appreciated that a first container can be shoved into a second container, until the point along the wall portion of the second container where the circumference is substantially equal to the circumference of the bottom of the first container.

In order to facilitate the use of the container set 70, each container can include an indication of its maximum capacity. The indication can be in any measurement system, such as liters, ounces etc, and it can be integrally formed with container, for example, on the wall portion or on its bottom. According to an example, the indication can be in Braille script, thus allowing blind user, to select the appropriate container.

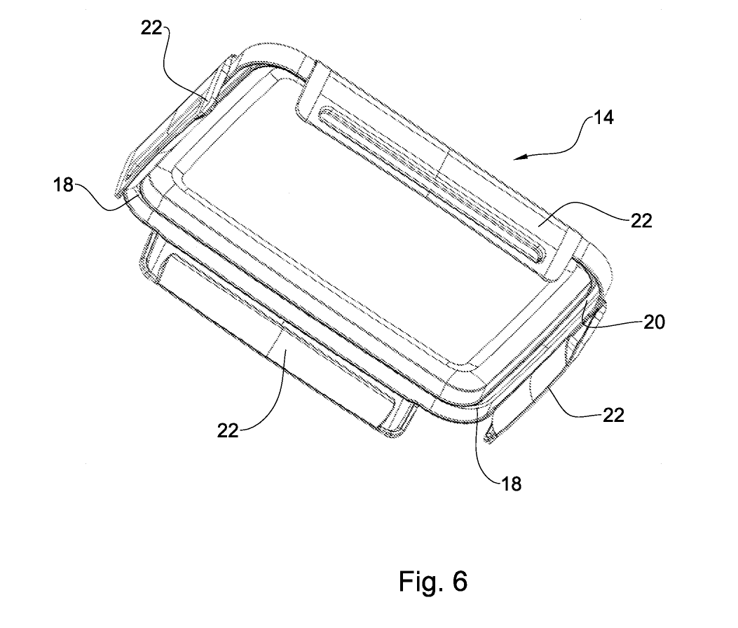

As seen in FIG. 6, the inside of lid member 14 includes a channel 18 defined about the perimeter thereof, configured for receiving the top of wall portion 12a. Inside channel 18 there is provided a silicone seal 20 mounted therein (best seen in FIG. 2b). Silicone seal 20 is integrally molded inside channel 18, so as to preclude displacement thereof. This is particularly useful when vacuum is created inside container body 12, thus, sometimes causing silicone seal 20 to be forced out of channel 18. In addition, integrally molding silicone seal 20 with lid member 14 substantially prevents the formation of gaps and spaces between the seal and the channel, in which bacteria can grow and accumulate. Silicone seal 20 can include antibacterial component for eliminating bacteria and/or fungal, such as antibacterial nano silver particles, as known in the art. When lid member 14 is placed on container body 12, the top of wall portion 12a is inserted into channel 18, while sealingly engaging silicone seal 20. Thus, the inside space of container body 12 is sealed, and the marital therein can be air-tightly stored. It is appreciated that the lid member can be molded thermoplastic member, integrally formed with a channel into which the silicone seal is injected.

According to one example, silicone seal 20 is integrally molded into channel 18 during the formation process of lid member 14. This can be carried out by injecting a thermoplastic material into a first mold cavity having a shape corresponding to a desired container body, thereby forming the container body. In addition, injecting a thermoplastic material into a second mold cavity having a shape corresponding to a desired lid member with a channel defined about the perimeter thereof for receiving a wall portion of the container body, when the lid member is placed thereon. Finally, injecting a silicone material into the channel, thereby forming a silicone seal configured for sealing engagement with the wall portion of the container body when the lid member is placed thereon.

Alternatively, silicone seal 20 is molded into a channel of an existing lid member. It is further appreciated that the container includes latching arrangement for securing the lid member to the wall portion of the container. The latching arrangement can include for example latching flaps on the lid member for securely engaging a shoulder defined on the wall portion of the container. It is appreciated that alternatively the latching flaps can be provided on the wall portion, and configured to securely engage a shoulder portion is provided on the lid member.

In any case, the latching arrangement is configured to secure the lid member to the wall portion, and in addition to ensure sealing engagement between the silicone seal and the wall portion.

Referring now to FIG. 7a, there is provided according to an example of the presently disclosed subject matter, a storage container generally indicated 30. Storage container 30, is substantially the same as storage container 10 of FIG. 1a, and includes a container body 32, and a lid member 34 having a plurality of latching flaps 36 for securing thereof to container body 32. Storage container 30 further includes a valve 38 for releasing pressure accumulated therein. Valve 38 is a check valve allowing flow in one direction, thus, allowing fluids, such as gas, and vapor to escape container 30, while blocking air and other fluids from entering container 30. In the illustrated example, valve 38 is an umbrella valve, also known as a “mushroom valve”. It will be appreciated that the valve can be any other valve suitable for unidirectional flow, such as allowing fluid to escape the container, while stopping fluids from outside the container to enter therein. The valve allows steam accumulated in the container to escape there from, this way, food products can be heated and cooked while being air-tightly stored in the container. It is appreciated that the storage container 30 can further include a silicone seal 35 molded into the perimeter of its lid for sealingly engaging the wall portion of the container, as described herein above with regards to FIG. 7a. The silicone seal 35 provides an air-tightly space inside the container when the lid is placed thereon. The valve on the other hand allows gases inside the container, for example, gases emitted from the foods contained inside the container, to be released.

As best seen in FIG. 7b, valve 38 includes a seat 40 having an aperture 42 for seating a valve stem, and at least one, and preferably a plurality of flow ports 44, configured to allow flow of fluids from container 30. In addition, valve 38 includes a skirt 46 for sealing flow ports 44, and a stem 48 coupled to the bottom of skirt 46, and seated in aperture 42. (The valve in FIG. 7a is shown without the stem 48 and the skirt 46) Skirt 46 is made of an elastic material which can be deformed as a result of pressure inside container 30, and includes a shape substantially corresponding to the contour of seat 40, thus sealing all of flow ports 44. Steam 42 includes a retaining knob 44 having a circumference larger than the size of aperture 42, thus retaining stem 48 inside aperture 42.

According to the illustrated example, seat 40 includes a circular shape, and skirt 46 includes a circular shape having a diameter slightly smaller than the diameter of seat 40. Aperture 42 is defined substantially at the center of seat 40, and flow ports 44 are defined around aperture 42. Stem 48 is mounted, and preferably integrally formed, at the center of skirt 46. This way, when steam 48 is mounted inside aperture 42, the periphery of skirt 46 covers and seals flow ports 44. Skirt 46 further includes a bore 50 substantially at the center thereof, which can extend into stem 48. Bore 50, allows for radially outwardly deformation of skirt 46, thereby unsealing flow ports 44. It will be appreciated that bore 50 is not opened to the inside of container 30, thus, does not allow for flow of fluids therefrom.

When the pressure inside container 30 is higher than the pressure outside thereof, the periphery of skirt 46 is slightly lifted from seat 40, thereby unsealing one or more flow ports 44, thus, allowing flow of fluids, such as gas and vapor, from container 30. It will be appreciated that the amount of pressure required to deformed skirt 46 thereby unsealing flow ports 44, can be predefined. This can be carried out by selecting the martial and shape of skirt 46 thereby defining the flexibility of its periphery.

Valve 38 can be defined on lid member 34, as in the illustrated example, or alternatively can be defined on container body 32. It will be appreciated that container body 32 can made in such a way which allows the user to selectively cover it with lid member 34 having a valve 38, or alternatively, with lid member which does not include a valve 38, such as lid member 14 of FIGS. 1a-3.

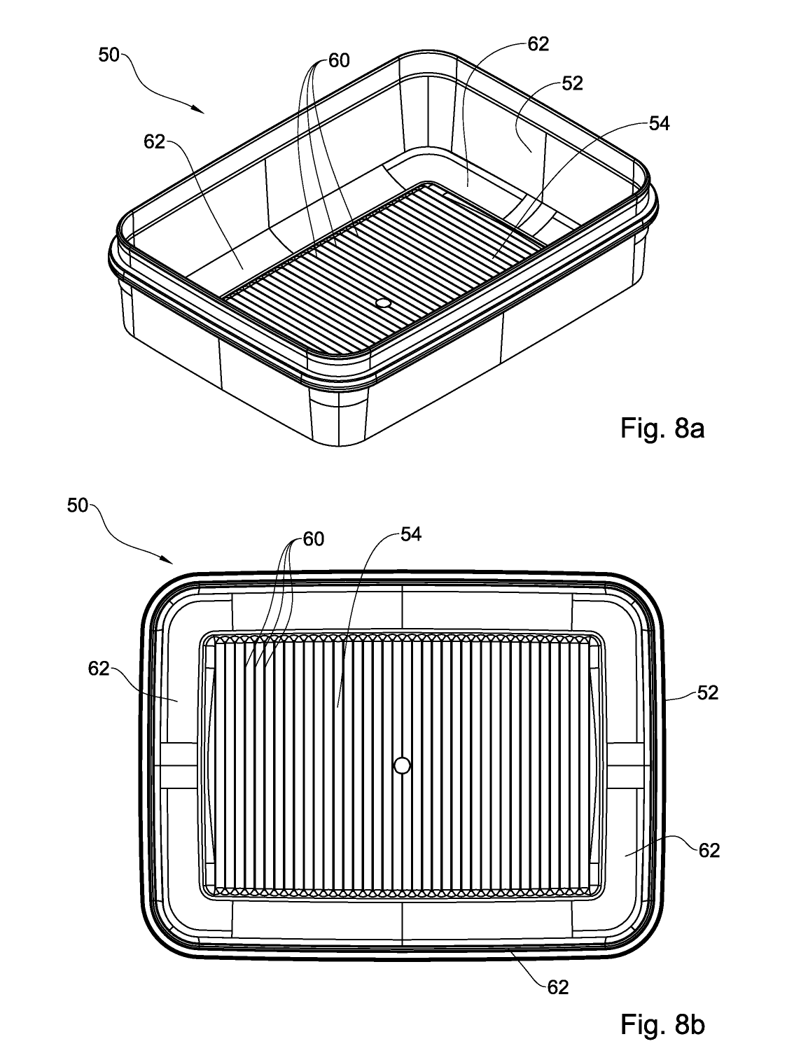

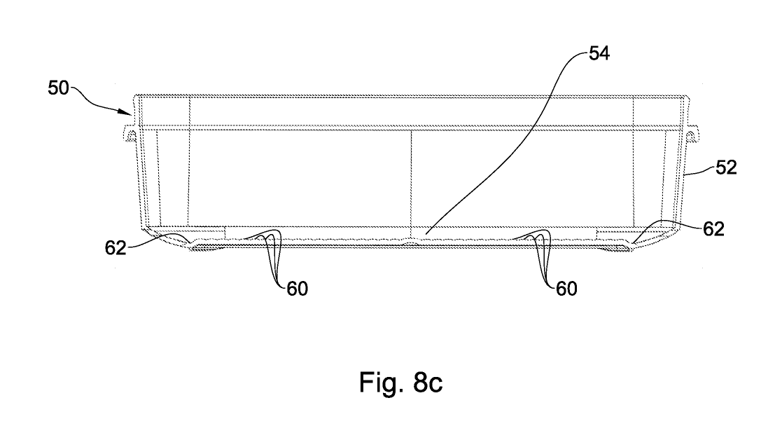

Referring now to FIGS. 8a to 8c, there is provided according to an example of the presently disclosed subject matter, a storage container generally indicated 50. Storage container 50 includes a wall portion 52, here illustrated as a rectangular wall, and a bottom portion 54, defining the inside bottom of container 50. Bottom portion 54 includes a plurality of ridges 60 for receiving liquids dripped and/or extracted from the material contained in container 50. Bottom portion 54 can further include a drainage channel 62 defined about at least a portion of the perimeter of bottom portion 54, for receiving liquids collected in ridges 60. Drainage channel 62 is in flow communication with ridges 60, and can be deeper than ridges 60, so as to allow liquids from ridges 60 to gravitate therein. This way, the material in container 50 is disposed substantially on top of ridges and is substantially separated from the liquids, which is drained into ridges 60 and drainage channel 62. This can be particularly useful when container 50 contains food products, which can get spoiled when soaked in liquid.

According to an example of the invention, the container further includes volume markings for measuring the volume of the contents inside the container. The volume markings can be in accordance with any volume measurement system, such as liter, ounces etc. The markings are preferably integrally formed on the wall portion of the container, alternatively, the markings can be carved, printed or glued to the container.

1. A storage container comprising:
a container body having a wall portion and a bottom portion, said container body is configured for airtight storage of material;
a lid member for air-tightly covering said container body, said lid member having a channel defined about the perimeter thereof; and
a molded silicone seal mounted in said channel, being configured to sealingly engage the upper perimeter of said wall portion when said lid is placed on said container body.

2. The storage container of claim 1, wherein said lid further comprises pressure relief valve mounted thereon.

3. The storage container of claim 1, further comprising latching arrangement configured to secure said lid member to said wall portion.

4. The storage container of claim 3, wherein said latching arrangement is configured to tightly secure said lid member to said wall portion thereby sealingly engaging said upper perimeter of said wall portion with said silicone seal.

5. The storage container of claim 3, wherein said latching arrangement comprises at least two latching flaps mounted on said lid member, being configured for snap fit engagement with a shoulder portion defined along the outside of said wall portion.

6. The storage container of claim 1, wherein said silicone seal comprises antibacterial component.

7. The storage container of claim 1, wherein said wall portion comprises a graduate scale having indicia.

8. The storage container of claim 1, wherein said container body further comprises a drainage channel defined about the perimeter of said bottom portion being configured for collecting liquid from the material stored inside said container body.

9. The storage container of claim 8, wherein said container body further comprises a plurality of grooves defined on said bottom portion, said grooves being in flow communication with said drainage channel.

10. The storage container of claim 1, wherein said lid member further comprises a valve mounted therein and being configured for releasing pressure accumulated inside said container body, when said lid member is placed thereon.

11. The storage container of claim 10, wherein said valve comprises an aperture defined in said lid member for seating a valve stem, and at least one flow port, configured to allow flow of fluids from the container, said flow ports being sealed by a skirt disposed on the outside of said lid member and being coupled to said stem, and configured for radially outwardly deformation thereof in response to pressure accumulating inside the container.

12. A method for manufacturing a storage container configured for airtight storage of material, and having a container body and a lid member configured for covering the container body and having a channel defined about the perimeter thereof for receiving a wall portion of the container body, the method comprising:
injecting a thermoplastic material into a first mold cavity having a shape corresponding to the container body, for forming the container body;
injecting a thermoplastic material into a second mold cavity having a shape corresponding to the lid member for forming the lid member and the channel defined therein; and
injecting a silicone material into the channel, thereby forming a silicone seal configured for sealing engagement with the wall portion of the container body when the lid member is placed thereon.

13. The method of claim 12, wherein said silicone material further comprises antibacterial component configured for eliminating bacteria from inside the container body.

14. The method of claim 13, wherein said antibacterial component is nano-silver particles.

15. The method of claim 12, further comprising forming an aperture in the lid member, and mounting therein a valve configured for releasing pressure accumulated inside the container body, when the lid member is placed thereon.

16. The method of claim 15, wherein said valve comprises a valve stem seated in said aperture, and a skirt disposed on the outside of said lid member and configured to seal at least one flow port formed in said lid member, said skirt is being coupled to said stem, and configured for radially outwardly deformation thereof in response to pressure accumulating inside the container.

17. The method of claim 16, wherein said aperture and said at least one flow port are formed in the injecting process of said lid member.

18. The method of claim 12, further comprising providing latching arrangement configured for securing the lid member to a wall portion of the container body.

19. The method of claim 18, wherein said latching arrangement comprises at least two latching flaps integrally formed on said lid member, being configured for snap fit engagement with a shoulder portion formed along the outside of said wall portion.

20. The method of claim 19, wherein said latching flaps are integrally formed with a hinge line in the form of a flexible portion, configured for pivoting latching flap thereabout.
